(19) United States
(12) Patent Application Publication
(10) Pub. No.: US 2025/0023336 A1
(43) Pub. Date: Jan. 16, 2025

(54) HOUSING FOR A CHARGING STATION AND CHARGING STATION WITH SUCH A HOUSING

(71) Applicant: ads-tec Energy GmbH, Nürtingen (DE)

(72) Inventors: Thomas SPEIDEL, Markgröningen (DE); Roman MOLCHANOV, Neckartenzlingen (DE); Andreas GREIF, Weilheim (DE)

(21) Appl. No.: 18/769,474

(22) Filed: Jul. 11, 2024

(30) Foreign Application Priority Data
Jul. 11, 2023 (DE) 102023118367.2

(51) Int. Cl. H02G 11/00; B60L 53/18; B60L 53/30; H02J 7/00

(52) U.S. Cl. CPC H02G 11/00; B60L 53/18; B60L 53/30; H02J 7/0042

(57) ABSTRACT

The invention relates to a housing for a charging station with an opening cladding element delimiting at least one charging cable opening, wherein
the housing has at least one charging cable arm, which is configured to support a charging cable of the charging station, which charging cable is guided through the at least one charging cable opening, at least in some areas, wherein
the at least one charging cable arm is rotatable relative to the opening cladding element about an axis of rotation, wherein
the axis of rotation is at least locally perpendicular to the opening cladding element, and wherein
the at least one charging cable arm is elastic.

### CROSS REFERENCE TO RELATED APPLICATIONS

The present application claims the priority of German patent application No. 102023118367.2, filed on Jul. 11, 2023, which is expressly incorporated herein by reference in its entirety.

The invention relates to a housing for a charging station and a charging station having such a housing.

Charging stations, in particular fast charging stations for vehicles with an electric drive, are becoming increasingly important. The use of such a charging station should be as simple and convenient as possible for the user. In known charging stations, the length of a charging cable is selected in such a way that the charging cable does not touch the ground where the charging station is installed when it is not in use-if a charging plug of the charging cable is arranged on the charging station. This prevents the charging cable from being soiled and/or damaged by the ground. It also prevents a vehicle from driving over the charging cable and/or parking on it. The disadvantage of this is that the resulting limited length of the charging cable restricts the radius of action of the charging station, in particular a distance between a charging socket of the vehicle to be charged and the charging station. With the known charging stations, it is thus necessary to park the vehicle exactly relative to the charging station, as otherwise the charging plug cannot be arranged in the charging socket.

The invention is thus based on the object of creating a housing for a charging station and a charging station having such a housing, wherein the disadvantages mentioned are at least partially eliminated, preferably avoided.

The object is solved by providing the present technical teaching, in particular the teaching of the independent claims and the embodiments disclosed in the dependent claims and the description.

The object is solved in particular by creating a housing for a charging station with an opening cladding element delimiting at least one charging cable opening. The housing has at least one charging cable arm, which is configured to support a charging cable of the charging station, which charging cable is guided through the at least one charging cable opening, at least in some areas. In particular, the at least one charging cable arm is configured to accommodate and/or guide at least some areas of the charging cable of the charging station, which charging cable is guided through the at least one charging cable opening. Furthermore, the at least one charging cable arm is rotatable relative to the opening cladding element about an axis of rotation, wherein the axis of rotation is at least locally perpendicular to the opening cladding element. In addition, the at least one charging cable arm is clastic. Advantageously, an action radius of the at least one charging cable is increased by means of the at least one charging cable arm. In particular, the at least one charging cable is guided by means of the at least one charging cable arm in an elevated position to a motor vehicle to be charged, so that the at least one charging cable, in particular a charging plug of the at least one charging cable, can be arranged in a simple manner on the motor vehicle to be charged-in particular in a charging socket of the motor vehicle. In addition, the increased radius of action increases the number of possible parking positions for charging the vehicle at the charging station. Furthermore, the elastic design of the at least one charging cable arm allows the at least one charging cable arm to be bent in an at least partially reversible manner. Advantageously, in the event of a collision between a motor vehicle and the at least one charging cable arm, neither the motor vehicle nor the at least one charging cable arm is damaged.

In one embodiment, the at least one charging cable opening is designed as a polygon and/or arc polygon, in particular circular. In particular, the circular charging cable opening has a clear diameter which is at least as large, in particular exactly as large, as a diameter of the charging cable guided through the at least one charging cable opening.

In particular, the housing has a ceiling cladding element and at least one side cladding element, wherein one side cladding element of the at least one side cladding element is designed as the opening cladding element. In one embodiment, the housing has at least four side cladding elements, in particular exactly four side cladding elements.

In one embodiment, the opening cladding element is planar. In addition, the housing is designed in particular in such a way that when the housing is used as intended as the housing of a charging station, the opening cladding element is perpendicular to a ground where the charging station is set up, in particular perpendicular to a motor vehicle parking space at the charging station. In this case, the axis of rotation is aligned parallel to the ground.

In one embodiment, the at least one charging cable arm is arranged on the opening cladding element in such a way that, when the housing is used as intended, one end of the at least one charging cable arm facing the opening cladding element and the motor vehicle parking space are at a distance-measured vertically or perpendicularly-of 100 cm to 250 cm, in particular of 150 cm to 250 cm, in particular of 200 cm to 230 cm, in particular of 210 cm to 220 cm. In particular, the distance between the end of the at least one charging cable arm facing the opening cladding element and the motor vehicle parking space is selected such that a user of the charging station can walk upright under the charging cable arm-in particular without touching the charging cable arm.

In one embodiment, the housing encases an interior of a charging station at least partially, in particular completely, when used as intended, wherein in particular an installation surface of the charging station is not enveloped by the housing.

In particular, a material from which the at least one charging cable arm is made has a modulus of elasticity of 1000 N/mm² to 1800 N/mm².

According to a further development of the invention, it is provided that the at least one charging cable arm is displaceably connected to a housing body of the housing in such a way that it can optionally be arranged in an operating position and in a transport position. In particular, the at least one charging cable arm is connected to the housing body so as to be rotatable about the axis of rotation, the at least one charging cable arm can thus be rotated about the axis of rotation in order to arrange it optionally in the operating position and in the transport position. The housing body is formed in particular by the ceiling cladding element and the at least one side cladding element.

In particular, the at least one charging cable arm is connected to the opening cladding element in such a displaceable manner that it can be optionally arranged in the operating position or in the transport position.

In particular, in the operating position, the at least one charging cable arm extends away from the housing, in particular from the opening cladding element. In particular, in the operating position, the at least one charging cable arm is designed in such a way that, when the housing is used as intended, one end of the at least one charging cable arm facing away from the opening cladding element and the motor vehicle parking space are at a distance of 100 cm to 250 cm, in particular 150 cm to 250 cm, in particular 200 cm to 230 cm, in particular 210 cm to 220 cm. Alternatively or additionally, the at least one charging cable arm is almost parallel, in particular parallel, to the motor vehicle parking space in the operating position when the housing is used as intended. Alternatively or additionally, the at least one charging cable arm forms an angle of 10° to 50°, in particular 30°, with the opening cladding element in the operating position.

In the context of the present technical teaching, an imaginary charging cable arm path is considered for determining the angles, wherein the imaginary charging cable arm path is determined by a straight line through the end of the at least one charging cable arm facing away from the opening cladding element and the end of the at least one charging cable arm facing the opening cladding element.

In particular, in the transport position, the at least one charging cable arm rests at least partially against the housing, in particular against the opening cladding element. Advantageously, this enables compact transportation of the housing. It is also possible to make use of the inherent elasticity of the at least one charging cable arm and to attach it to the housing, for example with a strap or similar, in order to achieve the most compact shape possible in the transport position.

In one embodiment, the charging station has a locking device by means of which the at least one charging cable arm can be locked in the operating position. Alternatively or additionally, the at least one charging cable arm can be locked in the transport position by means of the locking device.

According to a further development of the invention, it is provided that the at least one charging cable arm is arranged, at least in some areas, to fully embrace the charging cable—i.e. along a closed circumferential line around the circumference of the charging cable. Advantageously, in this way at least one charging cable is protected by the charging cable arm.

In one embodiment, the at least one charging cable arm is at least partially tubular. Alternatively, the charging cable arm is at least partially pipe-shaped.

According to a further development of the invention, it is provided that the at least one charging cable arm is straight. Alternatively, the at least one charging cable arm is curved.

According to a further development of the invention, it is provided that the at least one charging cable arm is rotatably connected to the housing body—in particular rotatably about the axis of rotation—by means of a charging cable arm support.

According to a further development of the invention, it is provided that the at least one charging cable arm support has a charging cable cut-out and is arranged on the at least one opening cladding element in such a way that the at least one charging cable opening is covered, at least in some areas, by the at least one charging cable arm support. The charging cable cut-out is aligned with the at least one charging cable opening. Advantageously, the at least one charging cable can thus be routed directly and protected from an interior of the charging station through the at least one charging cable opening into the at least one charging cable arm.

According to a further development of the invention, it is provided that the at least one charging cable arm has a charging cable fixing element at an end facing away from the opening cladding element.

In particular, the charging cable fixing element is arranged to prevent movement of a charging cable supported by the at least one charging cable arm relative to the at least one charging cable arm in at least one direction. Advantageously, twisting and/or friction of the at least one charging cable in the at least one charging cable arm can at least be reduced, in particular prevented, by means of the fixing element.

According to a further development of the invention, it is provided that the at least one charging cable arm has a length of 80 cm to 150 cm, in particular of 100 cm to 130 cm, in particular of 110 cm.

According to a further development of the invention, it is provided that the at least one charging cable arm is designed as a steel spring, in particular a coil spring, which can accommodate the charging cable in its interior. Alternatively, the at least one charging cable arm has a plastic material. Alternatively, the at least one charging cable arm consists of plastic.

In particular, the at least one charging cable arm has polypropylene and/or polyethylene. Alternatively, the at least one charging cable arm consists of polypropylene. Alternatively, the at least one charging cable arm consists of polyethylene.

In one embodiment of the at least one charging cable arm designed as a steel spring, the steel spring is at least partially covered with at least one elastomer, in particular polypropylene and/or polyethylene. In particular, the at least one elastomer, in particular polypropylene and/or polyethylene, encases the steel spring. Alternatively or additionally, the steel spring is formed around at least one pipe-shaped or tubular elastomer part, wherein the charging cable can be arranged in the interior of the elastomer part—and thus at the same time in the interior of the steel spring, which is designed in particular as a coil spring. In particular, the elastomer part has polypropylene and/or polyethylene or consists of polypropylene and/or polyethylene.

The object is also solved by creating a charging station having a housing according to the invention or a housing according to one of the embodiments described above. The charging station also has at least one charging cable, wherein the at least one charging cable is guided out of the charging station through the at least one charging cable opening. Furthermore, the at least one charging cable is at least partially supported by the at least one charging cable arm. In connection with the charging station, the advantages already explained in connection with the housing apply in particular.

In electrical engineering, a charging station is any device or electrical system, in particular stationary or mobile, which is used to supply energy to mobile battery-powered devices, machines or motor vehicles by simply plugging them in without necessarily having to remove the energy storage device-such as the traction battery of an electric car. Charging stations for electric cars are sometimes also referred to as “electric charging stations” and can include several charging points. High performance charging systems or high power charging system (HPC systems) such as the combined charging system (CCS), which is widespread in Europe, arc particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics are usually located in the charging station. Since the direct current connections of the charging station are connected directly to the corresponding connections of the traction battery-without a detour through an AC/DC converter of the vehicle-high charging currents can be transmitted with low losses, which enables short charging times.

In one embodiment, the charging station is designed as a charging column. In particular, the charging station has at least one charging point, in particular exactly one charging point or exactly two charging points.

In particular, the charging station is designed as a fast charging station. In one embodiment, the charging station is designed as a battery-supported charging station, in particular as a battery-supported fast charging station.

In one embodiment, the at least one charging cable has a protective sheathing that at least partially encases the at least one charging cable. In particular, the at least one charging cable does not have the protective sheathing in the area of the at least one charging cable arm. In particular, the protective sheathing is only formed in an area of the at least one charging cable that is not supported by the at least one charging cable arm. In particular, the protective sheathing is formed between a charging plug of the at least one charging cable and the end of the at least one charging cable arm, which end faces away from the opening cladding element, in particular the charging cable fixing element.

In a further embodiment, the charging station, in particular the housing, has a charging plug suspension in which the charging plug of the at least one charging cable can be arranged when the at least one charging cable is not in use. In particular, a length of the at least one charging cable is selected such that the at least one charging cable does not touch the ground when not in use—and thus when arranged in the charging plug suspension.

In a further embodiment, the charging station has two charging points and thus two charging cables and two charging cable arms, wherein a first charging cable is at least partially supported by a first charging cable arm and a second charging cable is at least partially supported by a second charging cable arm. In particular, the charging station has the opening cladding element with two charging cable openings. Alternatively or additionally, in the operating position, the two charging cable arms form an angle of 80° to 160°, in particular 120°. Alternatively or additionally, the two charging cable arms are almost parallel, in particular parallel, to each other in the transport position and/or form an angle of at most 10°. Alternatively or additionally, the two charging cable arms are designed such that a first end of the first charging cable arm facing away from the opening cladding element and a second end of the second charging cable arm facing away from the opening cladding element are at a distance of 200 cm to 300 cm, in particular 260 cm. Alternatively or additionally, the two charging cable arms are designed such that a first end of the first charging cable arm facing the opening cladding element and a second end of the second charging cable arm facing the opening cladding element are at a distance of 50 cm to 100 cm, in particular 74 cm. Advantageously, this makes it possible to charge two vehicles simultaneously in a simple and convenient manner and without a prescribed alignment of the vehicles relative to each other and/or relative to the charging station.

The invention is explained in more detail below with reference to the drawing. The Figures show:

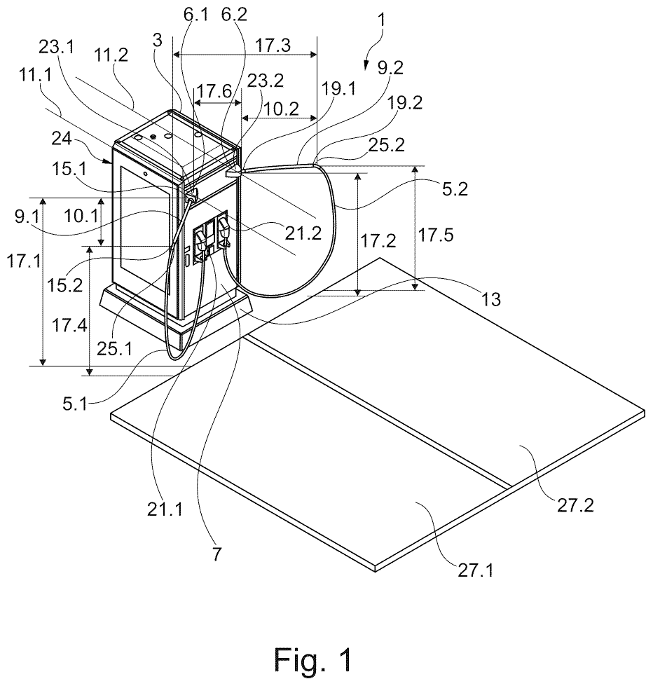

FIG. 1 shows a schematic representation of an embodiment example of a charging station in a first view,

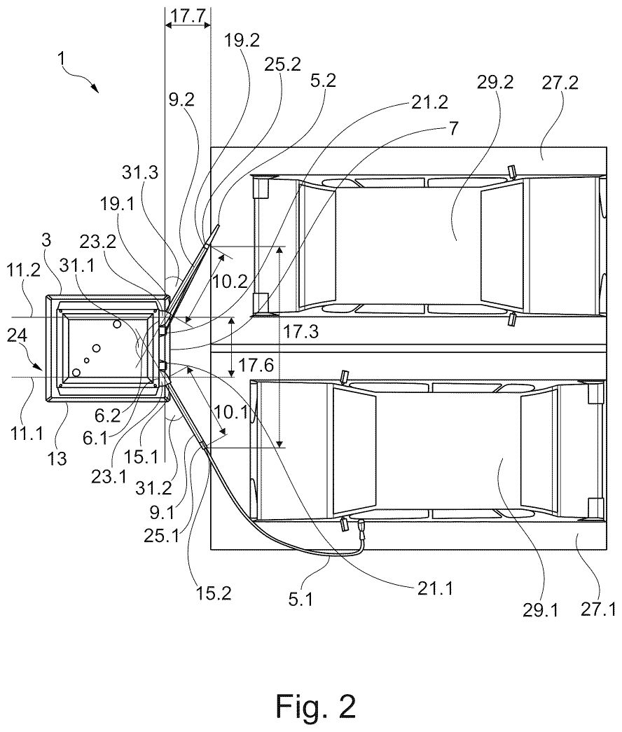

FIG. 2 shows a schematic representation of the embodiment example of the charging station in a second view, and

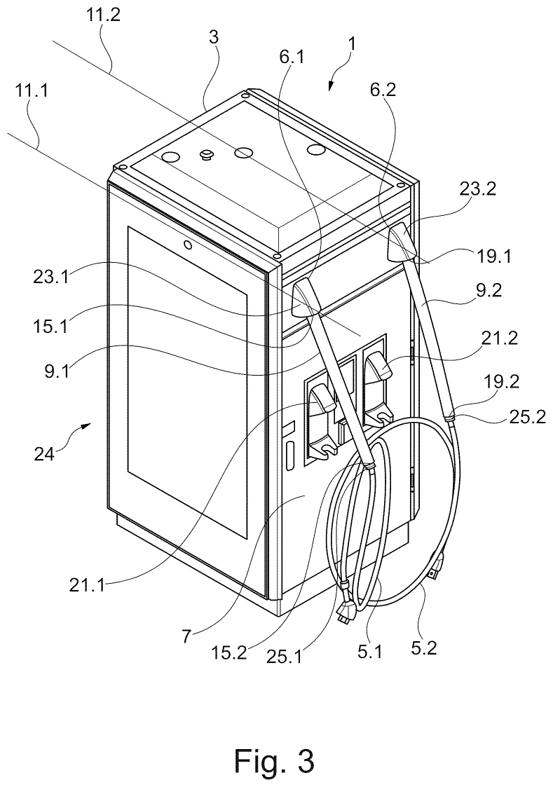

FIG. 3 shows a schematic representation of the design embodiment example of the charging station in a third view.

FIG. 1 shows a schematic representation of an embodiment example of a charging station 1 with an embodiment example of a housing 3 and a first charging cable 5.1 in a first view.

The first charging cable 5.1 is guided out of the charging station 1 through a first charging cable opening 6.1.

The housing 3 has an opening cladding element 7 that delimits the first charging cable opening 6.1. Furthermore, the housing 3 has a first charging cable arm 9.1, which is configured to support and optionally accommodate and/or guide, at least in some areas, the first charging cable 5.1 of the charging station 1, which first charging cable 5.1 is guided through the first charging cable opening 6.1. The first charging cable arm 9.1 is elastically designed and rotatable relative to the opening cladding element 7 about a first axis of rotation 11.1, wherein the first axis of rotation 11.1 is at least locally perpendicular to the opening cladding element 7. Preferably, the first charging cable arm 9.1 is configured, at least in some areas, to fully embrace the first charging cable 5.1.

In the embodiment shown, the charging station 1 also has a second charging cable 5.2, wherein the second charging cable 5.2 is guided out of the charging station 1 through a second charging cable opening 6.2. Furthermore, the opening cladding element 7 delimits the first charging cable opening 6.1 and the second charging cable opening 6.2. In addition, the housing 3 has a second charging cable arm 9.2, which is configured to support and optionally accommodate and/or guide, at least in some areas, the second charging cable 5.2 of the charging station 1, which second charging cable 5.2 is guided through the second charging cable opening 6.2. In addition, the second charging cable arm 9.2 is elastically designed and rotatable relative to the opening cladding element 7 about a second axis of rotation 11.2, wherein the second axis of rotation 11.2 is at least locally perpendicular to the opening cladding element 7. Preferably, the second charging cable arm 9.2 is configured, at least in some areas, to fully embrace the second charging cable 5.2.

Especially preferably, a material from which the first charging cable arm 9.1 and/or the second charging cable arm 9.2 is made has a modulus of elasticity of 1,000 N/mm² to 1,800 N/mm².

In one embodiment, a first length 10.1 of the first charging cable arm 9.1 is from 80 cm to 150 cm, in particular from 100 cm to 130 cm, in particular 110 cm. Alternatively or additionally, a second length 10.2 of the second charging cable arm 9.2 is from 80 cm to 150 cm, in particular from 100 cm to 130 cm, in particular 110 cm.

The opening cladding element 7 is preferably planar. Alternatively or additionally, the housing 3 is designed in such a way that the opening cladding element 7 is perpendicular to a ground 13 where the charging station 1 is set up. In this case, the axes of rotation 11.1, 11.2 are aligned parallel to the ground 13.

In the view shown, the first charging cable arm 9.1 and/or the second charging cable arm 9.2 are in an operating position. The first charging cable arm 9.1 and/or the second charging cable arm 9.2 extend away from the housing 3, in particular from the opening cladding element 7.

In one embodiment, the first charging cable arm 9.1 is arranged on the opening cladding element 7 such that an end 15.1 of the first charging cable arm 9.1 facing the opening cladding element 7 and a first motor vehicle parking space 27.1 are at a first distance 17.1 which is from 100 cm to 250 cm, in particular from 150 cm to 250 cm, in particular from 200 cm to 230 cm, especially preferably from 210 cm to 220 cm. Alternatively or additionally, the second charging cable arm 9.2 is arranged on the opening cladding element 7 in such a way that an end 19.1 of the second charging cable arm 9.2 facing the opening cladding element 7 and a second motor vehicle parking space 27.2 are at a second distance 17.2, which is from 100 cm to 250 cm, in particular from 150 cm to 250 cm, in particular from 200 cm to 230 cm, especially preferably from 210 cm to 220 cm. In particular, the first distance 17.1 is equal to the second distance 17.2. Alternatively or additionally, the first charging cable arm 9.1 and the second charging cable arm 9.2 are designed in such a way that, in the operating position, an end 15.2 of the first charging cable arm 9.1 facing away from the opening cladding element 7 and an end 19.2 of the second charging cable arm 9.2 facing away from the opening cladding element are at a third distance 17.3, which is from 200 cm to 300 cm, especially preferably 260 cm. Alternatively or additionally, the first charging cable arm 9.1 is designed such that, in the operating position, the end 15.2 of the first charging cable arm 9.1 facing away from the opening cladding element 7 and the first motor vehicle parking space 27.1 are at a fourth distance 17.4, which is from 100 cm to 250 cm, in particular from 150 cm to 250 cm, in particular from 200 cm to 230 cm, especially preferably from 210 cm to 220 cm. Alternatively or additionally, the second charging cable arm 9.2 is designed such that, in the operating position, the end 19.2 of the second charging cable arm 9.2 facing away from the opening cladding element 7 and the second motor vehicle parking space 27.2 are at a fifth distance 17.5, which is from 100 cm to 250 cm, in particular from 150 cm to 250 cm, in particular from 200 cm to 230 cm, especially preferably from 210 cm to 220 cm. Alternatively or additionally, the first charging cable arm 9.1 and the second charging cable arm 9.2 are designed such that, in the operating position, the end 15.1 of the first charging cable arm 9.1 facing the opening cladding element 7 and the end 19.1 of the second charging cable arm 9.2 facing the opening cladding element are at a sixth distance 17.6, which is from 50 cm to 100 cm, especially preferably 74 cm.

The housing 3 also has a first charging plug suspension 21.1 and a second charging plug suspension 21.2. When the charging cables 5 are not in use, the first charging cable 5.1 can be arranged in the first charging plug suspension 21.1 and/or the second charging cable 5.2 can be arranged in the second charging plug suspension 21.2. In particular, a length of the first charging cable 5.1 and/or the second charging cable 5.2 is selected such that the first charging cable 5.1 and/or the second charging cable 5.2 does not touch the ground 13 when not in use—and thus when arranged in the first charging plug suspension 21.1 and/or the second charging plug suspension 21.2.

Furthermore, the first charging cable arm 9.1 is rotatably connected to the housing body 24 via a first charging cable arm support 23.1, which is rotatable relative to the opening cladding element 7. Alternatively or additionally, the second charging cable arm 9.2 is rotatably connected to the housing body 24 via a second charging cable arm support 23.2, which is rotatable relative to the opening cladding element 7.

In one embodiment, the first charging cable arm 9.1 has a first charging cable fixing element 25.1 at the end 15.2 facing away from the opening cladding element 7. Alternatively or additionally, the second charging cable arm 9.2 has a second charging cable fixing element 25.2 at the end 19.2 facing away from the opening cladding element 7.

In particular, a motor vehicle 29, as shown in FIG. 2, is parked on one of the motor vehicle parking spaces 27.1, 27.2 for charging at the charging station 1. A motor vehicle 29.1 arranged on the first motor vehicle parking space 27.1 is charged by means of the first charging cable 5.1 and/or a motor vehicle 29.2 arranged on the second motor vehicle parking space 27.2 is charged by means of the second charging cable 5.2.

FIG. 2 shows a schematic representation of the embodiment example of the charging station 1 in a second view.

Identical and functionally identical elements are provided with the same reference numbers, so that reference is made to the previous description.

FIG. 2 shows a top view of the charging station 1, with a first motor vehicle 29.1 arranged on the first motor vehicle parking space 27.1 and a second motor vehicle 29.2 arranged on the second motor vehicle parking space 27.2. The first motor vehicle 29.1 is connected to the charging station 1 via the first charging cable 5.1.

In particular, the charging station 1 and the first motor vehicle parking space 27.1 and/or the second motor vehicle parking space 27.2 are at a seventh distance, which is from 50 cm to 100 cm, especially preferably 64 cm.

In one embodiment, in the operating position, the first charging cable arm 9.1 and the second charging cable arm 9.2 enclose a first angle 31.1 of 80° to 160°, especially preferably 120°. Alternatively or additionally, the first charging cable arm 9.1 and the opening cladding element 7 enclose a second angle 31.2 of 10° to 50°, especially preferably of 30°. Alternatively or additionally, the second charging cable arm 9.2 and the opening cladding element 7 enclose a third angle 31.3 of 10° to 50°, especially preferably of 30°.

FIG. 3 shows a schematic representation of the embodiment example of the charging station 1 in a third view.

FIG. 3 shows the charging station in a transport position. Compared to the operating position shown in FIGS. 1 and 2, the first charging cable arm 9.1 and/or the second charging cable arm 9.2 is rotated about the first axis of rotation 11.1 and/or the second axis of rotation 11.2. In particular, the first charging cable arm 9.1 and/or the second charging cable arm 9.2 run along the housing 3, in particular along the opening cladding element 7. Furthermore, the first charging cable 5.1 and/or the second charging cable 5.2 is rolled up so that compact transportation of the charging station 1 and/or the housing 3 is possible. In addition, it is possible for the charging cable arms 9.1, 9.2 to be pulled in the direction of the housing 3 by a strap or the like, utilizing their inherent elasticity, in order to achieve an even more compact shape.

Preferably, the first charging cable arm 9.1 and the second charging cable arm 9.2 are aligned almost parallel, in particular parallel, to each other in the transport position.

1. A housing for a charging station with an opening cladding element delimiting at least one charging cable opening, wherein
the housing has at least one charging cable arm, which is configured to support a charging cable of the charging station, which charging cable is guided through the at least one charging cable opening, at least in some areas, wherein
the at least one charging cable arm is rotatable relative to the opening cladding element about an axis of rotation, wherein
the axis of rotation is at least locally perpendicular to the opening cladding element, and wherein
the at least one charging cable arm is elastic.

2. The housing according to claim 1, wherein the at least one charging cable arm is displaceably connected to a housing body of the housing, in particular to the opening cladding element, in such a way that it can be optionally arranged in an operating position and in a transport position, wherein the charging station preferably has a locking device by means of which the charging cable arm can be locked in the operating position and/or in the transport position.

3. The housing according to claim 1, wherein the at least one charging cable arm is arranged, at least in some areas, to fully embrace the charging cable.

4. The housing according to claim 1, wherein the at least one charging cable arm is straight or curved.

5. The housing according to claim 1, wherein the at least one charging cable arm is rotatably connected to the housing body by means of a charging cable arm support.

6. The housing according to claim 1, wherein the at least one charging cable arm support has a charging cable cut-out and is arranged on the at least one opening cladding element in such a way that the at least one charging cable opening is covered, at least in some areas, by the at least one charging cable arm support, wherein the charging cable cut-out is aligned with the at least one charging cable opening.

7. The housing according to claim 1, wherein the at least one charging cable arm at an end facing away from the opening cladding element has a charging cable fixing element, which is preferably arranged to prevent a movement of a charging cable supported by the at least one charging cable arm relative to the at least one charging cable arm in at least one direction.

8. The housing according to claim 1, wherein the at least one charging cable arm has a length from 80 cm to 150 cm, in particular from 100 cm to 130 cm.

9. The housing according to claim 1, wherein the at least one charging cable arm
a) is designed as a steel spring—in particular at least partially covered with at least one elastomer—or
b) has a plastic, in particular polypropylene and/or polyethylene, or
c) consists of a plastic, in particular polypropylene or polyethylene.

10. A charging station comprising a housing according to claim 1 and at least one charging cable, wherein the at least one charging cable is guided out of the charging station through the at least one charging cable opening, and wherein the at least one charging cable is at least partially supported by the at least one charging cable arm.
